(19) United States
(12) Patent Application Publication
(10) Pub. No.: US 2013/0191857 A1
(43) Pub. Date: Jul. 25, 2013

(54) Method and System for a Vote Based Media System

(71) Applicant: R. Edward Guinn, South Burlington, VT (US)

(72) Inventor: R. Edward Guinn, South Burlington, VT (US)

(21) Appl. No.: 12/572,792

(22) Filed: Oct. 2, 2009

(51) Int. Cl. G06F 3/16; H04N 21/466

(52) U.S. Cl. CPC G06F 3/16; H04N 21/4668
USPC 725/24; 700/94

(57) ABSTRACT

Systems and methods for allowing a user to interact with a station so to have input into the selection of media to be broadcast. The user is able to vote on selections within a media library. The station tabulates the votes and broadcasts the highest ranked selection based on vote totals. The user is able to view the voting in real time and add additional votes, either positive or negative, to influence the ranking or can interact in other number of ways. The media can include audio or video broadcast over the internet via an internet radio station or through other types of networks.

### FIELD OF THE INVENTION

This invention relates to the field of network based media broadcast stations and in particular to a system for selecting the order of playing media files.

### BACKGROUND OF THE INVENTION

Popular music and other audio content has long been broadcast to the public, first by over the air radio stations and more recently through internet based radio stations. Internet radio is generally understood to include audio broadcasting via the Internet by using a streamlining medium. Internet radio stations may be associated with terrestrial radio stations or they can be Internet only.

The selection of songs to be played has long been an issue in radio stations, beginning with over the air radio stations and extending onto internet based radio stations. Typically a station manager or disc jockey will select the songs to be broadcast. The songs would often be selected to fit within a certain genre that defined the radio station, i.e., alternative rock, country, hip-hop, rap, jazz, etc. Users had very little input into the selection unless the radio station invited requests. Even then, it was often difficult to ascertain when the requested song might be played, and few requests were honored in the overall scheme.

The listeners of currently available radio stations are held captive to the programmer. Often, they are held in surprise with no knowledge of upcoming media broadcasts. There is little interactivity between the listeners and the programmers.

### SUMMARY OF THE INVENTION

The present invention addresses the problems of media broadcasts, such as radio broadcasts. The present invention provides an interface that allows the user to interact with the broadcast station and provide input as to upcoming broadcast of media, such as music. In a preferred embodiment, the user is able to vote on or against a particular song in order to influence the broadcast of that song. The station tabulates the votes in real time and plays the songs in order of their ranking based on vote totals. Thus, the user can influence the playing of songs by voting on their selection. For purposes of describing the present invention, a station is defined as a radio station, or any other type of station that broadcasts some form of media. Also for purposes of the present invention, media is defined as any type of content that can be broadcast, such as audio content, video content, or any form of content. Broadcast is also defined for purposes of the present invention as sharing of content with a plurality of listeners or viewers.

In a preferred embodiment of the present invention, the station is an internet radio station having a song library. A user interface, such as a web portal on a web server connected to the radio station provides the user with access to a directory of the station's media library. The media library, for a radio station, contains the audio content as well as data about that audio content that is shared by the station with users listening to the station. The media library can be searched by artist, song title, album, or other identifiers. The user selects their choice from the directory. The selection includes a voting option. In one preferred embodiment, the user may not only vote for a selection, they can also vote against it. These votes are tabulated in real time by the station and ranked in accordance with their vote total. The user can view this ranking on the user interface. As the broadcast of the current song is finished, the station will then broadcast the next highest ranked song. Thus the user, by their positive or negative vote, can help determine the song selections to be broadcast.

In another preferred embodiment of the present invention, the media files are designated within defined genres. For example, song files can be designated with Rock, Country, Rap, Hip-Hop, etc. genres. Within individual genres, subgenres can be set as well. The user can then search for selections by selecting an appropriate genre. Also, the broadcast station provides an individual station player for each genre. That allows listeners to select their favorite genre for listening or viewing. Listeners are not required to participate in the voting process but can simply listen or view the media as it is broadcast per the selected device. The user is able to vote for their selection within designated genres as well as to simultaneously select a station player where they can view the ranking of media within that or other genres.

The user, in one preferred embodiment, is limited to one vote per genre within a time period selected by the administrator. This prevents stuffing of votes to overly influence the broadcast of a particular song. The administrator can also limit the number of times a selection is broadcast over a set time period as well as to introduce new songs or popular songs into the ranking by automatically assigning additional voting blocks to that selection.

The system of one preferred embodiment uses a station hosted on at least one server. A web server hosts the user interface where the user can register, login, view selections, vote for selections and monitor the ranking of selections by vote totals. The user interface can also provide additional artist and song information, provide links to the artist home page, allow purchasing of downloadable music relative to that selection as well as many other functions. The station receives information about the voting from the web server, tabulates, relays the ranking back to the web server for display on the user interface and determines the next selection to be played. The station retrieves the selection from the file library and readies it for broadcast by a streaming music server to share the content with the listener. Other implementations are within the scope of the claimed invention as well.

These and other features of the present invention will be evident from the ensuing detailed description of preferred embodiments, from the drawings and from the claims.

### BRIEF DESCRIPTION OF THE DRAWINGS

FIG. 1 is a diagram of the system of a preferred embodiment.

FIG. 2 is an illustration of the News Index.

FIG. 3 is an illustration of the Vote selection.

FIG. 4 is an illustration of a screenshot of the user interface.

FIG. 5 is an illustration of a screenshot of the Music Index.

FIG. 6 is an illustration of a sub page of the Music Index.

FIG. 7 is an illustration of the Player selection.

FIG. 8 is an illustration of the station player.

### DETAILED DESCRIPTION OF PREFERRED EMBODIMENTS

A preferred embodiment of the present invention is discussed herein. It is to be expressly understood that the descriptive embodiments are provided herein for explanatory purposes only and are not meant to unduly limit the claimed inventions. The exemplary embodiments describe the present invention in terms of an internet radio station and the use of computer interfaces. It is to be understood that the present invention is intended for use with other types of radio stations, and other types of media transmitters as well as with other interfaces, such as smartphones, pdas, internet appliances, and other devices.

### Overview

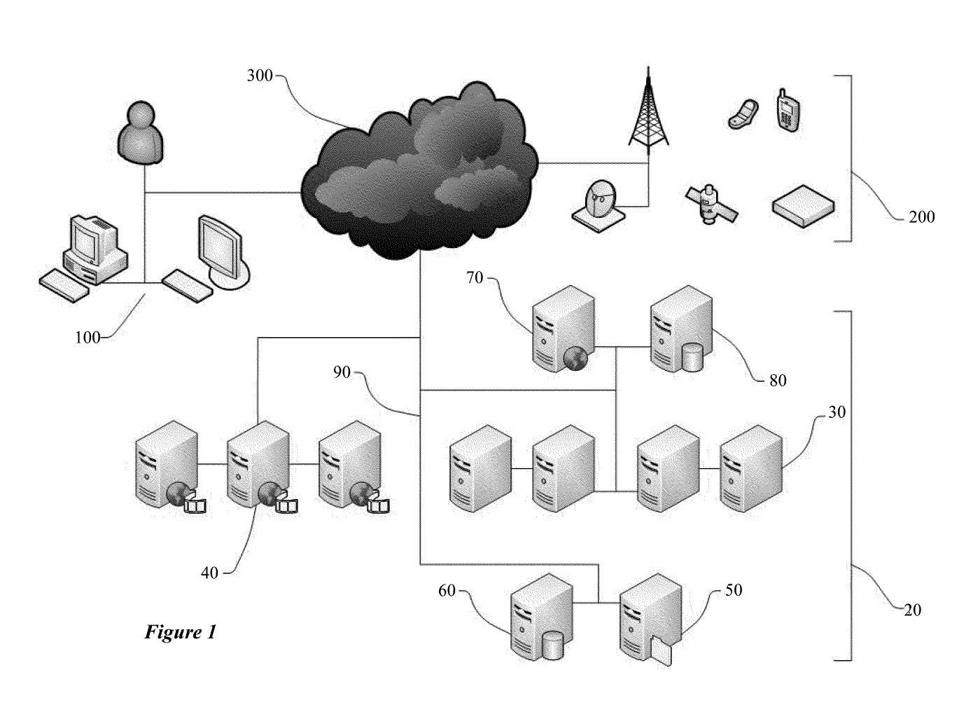

The system of a preferred embodiment of the present invention is illustrated in FIG. 1. The system 10 of this embodiment includes the internet radio station 20, user interface 100 and receivers 200. Receivers 200 can be a computer, smartphone or any type of internet receivable device. The system 10 enables users to vote their preference on a desired song which the station tabulates in real time and plays the most popular song at that time to the receivers 200. The songs can be received by receivers 200 without actually voting on the songs.

In the system 10, the user is able to select a music genre through the interface 100. The interface allows the user to select a song and place a vote for that song. The vote may also be a negative vote to reduce the popularity of the song in the voting. The top ranked song in terms of voting totals is then played next in the queue. The interface also allows the user to view the specific genre radio station page which includes the station player and the current list of songs in accordance with their real time popularity as determined by the number of positive user votes each song has received. Once the current song has finished playing, the next song in rank of popularity is then played. Thus, the user is able to interact with the station to add input in determining the songs to be played as well as to monitor when each song is to be played as well.

### System Hardware

The system essentially includes four components. The first component is the internet radio station 20. The second component is the user interface 100. The third component is the receivers 200. The fourth component is the Internet or network 300 through which the other three components communicate and interact.

The internet radio station 20 of this embodiment includes a number of servers that operate the system. These servers include the station servers 30, the streaming servers 40, file servers 50, song servers 60, web server 70 and user database server 80. It is to be expressly understood that the station 20 may include multiple servers at each of the designated servers, combined servers, co-locations, and other variations on the functionality that is provided by the severs described in this embodiment.

The station servers 30 coordinate with the other servers along network 90 to calculate the votes, select the “elected” song, receive the audio data file and song information, encode and share that information with the streaming servers 40 for broadcast to the receivers 200. Each genre of music will have its own station server. Each of the station servers access the song files from the file storage servers, plays the audio tracks and encodes the song files for sharing with the streaming media servers along with additional information about the song. As discussed below, the station server will communicate with the web server 70 to determine the next song to be shared with the streaming media servers.

The streaming servers 40 receive the songs in the form of data, encode that data in an appropriate protocol for broadcast to selected receivers and shares that encoded data via the internet or other network to the receivers 200. The streaming servers receive the data files for each song to be played from the station server, process that data by compressing the bit rate of the audio and encoding the data in a form that can be played over the user's receiver.

The file servers 50 contain all of the music data files in appropriate formats, i.e., mp3, way or other audio formats. The file servers will share these files as requested by the station servers to the station servers 30 or directly with streaming servers 40.

Song servers 60 contain numerical and text information relating to the files located in the file server. Files from song servers 60 will be coordinated with the files located in the file server 50 at the station servers 20 for sharing to the streaming servers 40.

The web server 70 manages the internet radio station interface as discussed in greater detail below. The web server 70 gathers, processes and sends the information to the user's browser via the user interface. Additionally, the web server 70 directly communicates with the station servers to receive information regarding track time, current song, and other information (title, artist, track, artwork, etc.) and share this information with the user interface. The web server 70 also communicates with the database server 80 to tabulate and keep track of the vote totals for each song and when it was last played. The web server will also access directly with the file server to keep track of the entire music library. In this embodiment, the web server will also communicate with the file servers to provide song previews to the user via the user interface. The file server will share a limited portion of a song to the web server which will encode it appropriately and send to the user interface for preview purposes.

A user database server 80 is also part of the internet radio station to register and monitor the users of the system as described in greater detail below. The web server 70 communicates with the user database server 80 along network 90 to input and update the information regarding users in the database server.

### User Interface

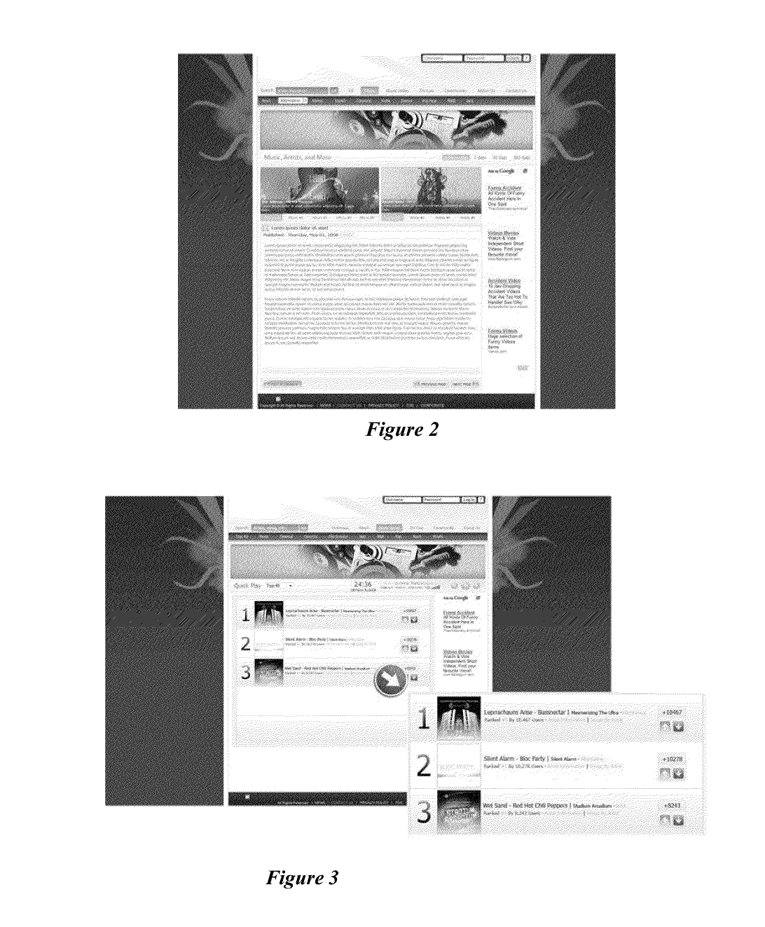

The user interface, in this embodiment, is a website portal, such as shown in the screenshot illustrated in FIG. 2. The portal is a graphical based interface that allows the display and input of information from and to the user. The website home page, in this particular embodiment, includes a number of user selections including but not limited to; User login 102, Overview 104, News 106, Music Index 108, Player 110, Community 112, About Us 114, and Search 118. These are generally defined as follows.

The Username login selection 102 is typically the first that is accessed by the user. If the user has not previously registered, then they are given the opportunity to do so. The registration process includes standard information, such as selecting a unique username, password, as well as additional demographic information if desired. This information is transmitted to the web server 70 and stored in database 80 along network 90. The user is then able to log in into the radio station 20. This process protects the integrity of the process to prevent multiple votes as described in greater detail below. Also, in an alternative embodiment, the system may be a subscription based service requiring credit card billing information. It is to be expressly understood that this embodiment is being described for explanatory purposes only and is not meant to limit the scope of the claimed inventions. The website portal, directories and links may take any number of forms.

The Overview 104, links to a page summarizing the current activity on the entire system. This can include any news in regard to the system or in general, up-to-date statistics regarding the voting on the songs, and any additional information that might be of interest.

The News selection 106, as shown in FIG. 2, links to the latest news regarding the system, artist news, music industry news or any other news that might be of interest. As shown in the illustration, advertisements can be dynamically linked to the news items in order to derive revenue. Also, current music linked to the news can be displayed, as shown in FIG. 3 along with the voting mechanism.

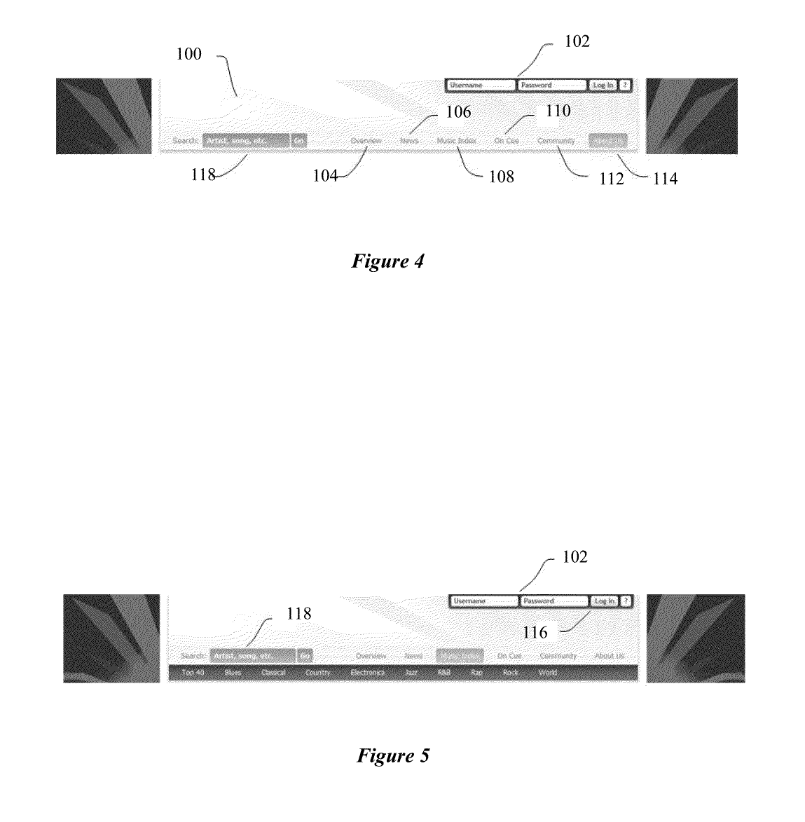

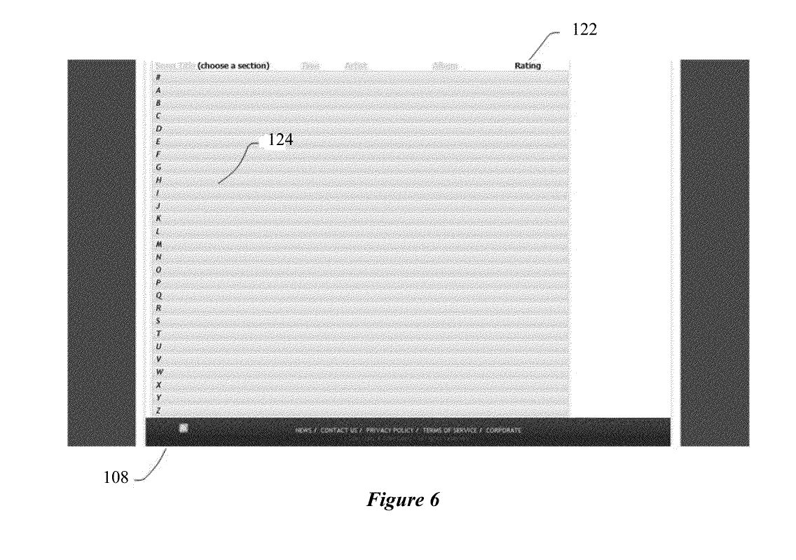

The Music Index selection 108 links to a page displaying the music database for the system. An example of this page is illustrated in FIGS. 4 and 6. The database can be ordered alphabetically by artist, by song title, by album title, keywords, rating 122 or any other identifier as shown at 124 in FIG. 6. Alternatively, the database can be ordered by genre, allowing the user to select an appropriate genre and subgenre for their music selection. For example, under the Rock selection, a submenu might be displayed that shows selections for Hard Rock, Classical Rock, Alternative Rock, Adult Contemporary etc. The page also includes a search box that allows the user to key in information on their search for a particular song, artist, album, etc.

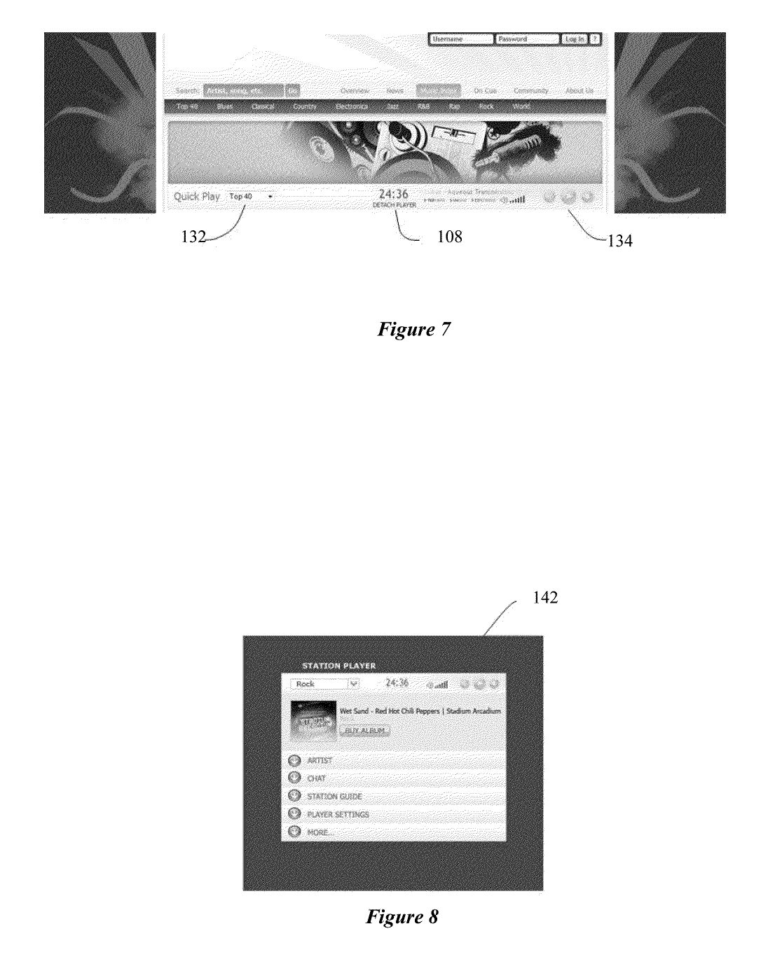

The Player selection 110 displays a directory of radio stations ordered primarily by their genre as illustrated in FIGS. 7 and 8. Once a genre or station has been selected at 132, the user can simply activate the player to listen to that station or be directed to a page for that station. The station page 140 as shown in FIG. 8 will display a top ten listing of songs in that genre. Next to each listed song is a menu allowing the user to select either a +1 or a −1 for that song, as shown in FIG. 3. Also, adjacent each listed song may be a link to the website for the artist for that particular song. A preview button may also be included to allow the song selection to be previewed. Another link may be adjacent each listed song to allow the user to purchase and/or download the song, album and provide other related services that allow the song to be purchased and downloaded. The station page will also include an audio player to allow the user to listen to the top ranked songs that are currently playing.

The Community selection 112 directs the user to a forum message board. The forum allows users to post, comment on posts and create new threads.

The User Profile selection 116 links to a form page that allows the user to create and modify information about the user that is publicly displayed to others using the interface. For example, the user may allow information and statistics regarding the songs that the user voted for or against. The user may allow other information such as age, location, favorite artists, hobbies, avatars, etc. to be publicly displayed as well.

The About Us selection 114 directs the user to a page that describes the system and the entities operating the system.

The system also allows the administrators to add additional content that may or may not pertain to music. Also, administrators may be able to insert advertisements in the form of banners, images and text into different areas of the website. These can be static advertisements or dynamic advertisements based on the user demographics, song selections or other criteria. These advertisements can be used to create revenue for the internet station.

### Operation

Once the user is logged into the station 20, the user then makes their music selection. Information, such as a particular song title, album, artist, etc. can be typed into search box 104 to find a particular song or directory of results from which the song can be selected. Alternatively, if the user does not have sufficient information, or if they do not have a particular song in mind, they can select the Music Index button 108. This directs them to a submenu directory, such as the screenshot shown in FIG. 6. The directory will list a number of genres from which the user may select. Additionally, under a particular genre, there may be additional subgenres that may be selected.

Once the user has selected a song, the song is displayed along with an option to vote on that song by selecting a (+) to vote for that song or a (−) to vote against that song. The user may also, in one embodiment, select to preview the song. This causes a short segment of the song to be streamed so the user may decide whether or not to vote for or against it. Once the user has voted for a song within a particular genre, the user is blocked from voting again in that genre for a time period that is set by the administrator, such as five minutes. The user may vote within other genres during this time out period.

The user can then select the player (or a sub station) for the particular genre by selecting the Station Player 110 and then selecting the appropriate genre. The user will then be directed to the station page for that genre. There, the user can monitor the rankings of the songs (and hopefully their song selection) to determine the likelihood of their song selection being played. Additional votes can be made once the time out period has expired to increase or decrease the popularity rankings of songs listed on the station page.

The administrator can set limits on the ranking of songs on the station page, such as setting a time limit on how frequently a song may be played during a defined period, or not allowing a song to be listed until it has a certain percentage of votes within the song's defined genre. The administrator shall also have privileges that allow popular and/or new songs to be automatically awarded additional votes to increase the likelihood that those songs will be moved to the top ten listing. The administrator shall also set criteria that selects the song to be played in the event of a tie vote. These criteria can include the overall popularity of the song, the number of positive votes received for each song and/or the frequency of the song selections or other criteria.

Thus, the system as described above allows a user to interact with the station by providing input and thus influence the likelihood of a particular song being played over a station; while monitoring its likelihood in real time. The user can access the system over any internet capable device, including desktop computer, laptop computers, smart phones, or any internet appliance.

It is to be expressly understood that the claimed inventions are not to be limited to the above descriptive embodiments. Other variations and embodiments are considered to be within the scope of the claimed inventions. For example, and without limitation, the system could be used to broadcast video files from a video library. The system could sort the videos by designated genres, allow users to vote for the most popular videos and display this ranking to users so they could determine the most popular videos. In one embodiment, the videos would be broadcast to video receivers, while in another, the ranking would allow the user to select the videos. Another example of an alternative embodiment is the use of a system set up in an establishment that plays recorded music. The patrons could access the media library, such as a jukebox or DJ station, select files, vote on them and the system would vote on the highest ranked media, such as a song, video, etc. as opposed to a single individual determining the songs that will be played for the entire establishment.

These and other embodiments are considered to be within the scope of the claimed inventions. For example, research may be derived from the collected statistics for each of the stations. This might include, but is not limited to: utilizing information collected from individual user's demographics and song selections to track and monitor popularity rankings and/or to forecast possible negative trends in the future marketability of songs or other media by artists, record companies or any other entity in or related to the industry.

1. A system for broadcasting media content, said system comprising:
at least one computer server;
a media station hosted on said at least one computer server;
a media library communicating with said media station;
a plurality of media files stored in said media library;
a user interface communicating via a network with said media station;
a listing displayed on said user interface of media files stored on said media library;
a voting option displayed on said listing for each of said media to allow a user to vote relative to a selected media file;
a tabulation mechanism on said media station to tabulate votes for each of said media files and determine the highest ranked media file based on voting totals; and
a broadcasting mechanism on said media station to broadcast the media file from said media library that has been determined to be the highest ranked based on voting totals.

2. The system of claim 1 wherein said system further includes:
a station player on said user interface for displaying a list of the top ranked media files at that particular time according to voting totals.

3. The system of claim 1 wherein said listing display includes:
a display of said media files sorted in accordance with the genre of said media.

4. The system of claim 1 wherein said media files include:
audio media files.

5. The system of claim 1 wherein said media files include:
video media files.

6. The system of claim 1 wherein said voting option includes:
a first voting option that provides a positive vote for the selected media file; and
a second voting option that provides a negative vote for the selected media file.

7. The system of claim 1 wherein said system further includes:
said tabulating mechanism tabulates determines the media files that receives the most votes by genre; and
said user interface includes a station player for each genre of media; and
each of said station players displays a ranking of the media files for the genre of that station player based on the highest voting total for each of the media files.

8. The system of claim 1 wherein said media station includes:
a web server for receiving and transmitting information with said user interface;
a station server for receiving information from said web server, tabulating the vote totals for each media file, transmitting that information to said web server and for selecting the highest ranking media file at a particular time; and
a media server for broadcasting the highest ranking media file as determined by the station server.

9. A method for selecting media for broadcast over a network using a media station having a media file library and connected over a network to a user interface, said method comprising the steps of:
selecting a media file from the media library as displayed on the user interface;
voting in regard to said selected media file;
tabulating votes at said media station for each of the media files; and
broadcasting the highest ranked media file.

10. The method of claim 9 wherein said method further includes the step of:
displaying a ranking of media files based on their vote totals on said user interface.

11. The method of claim 9 wherein said method includes the steps of:
tabulating votes on media files within a designated genre to which the media file has been designated; and
broadcasting the highest ranked media file based on total votes for that genre over a station player assigned to that genre.

12. The method of claim 9 wherein said step of voting on a selected media file includes:
selecting a positive vote to increase the ranking of the selected media file; and
selecting a negative vote to decrease the ranking of the selected media file.

13. The method of claim 9 wherein said step of selecting a media file includes:
selecting an audio file.

14. The method of claim 9 wherein said step of selecting a media file includes:
selecting a video file.

15. The method of claim 9 wherein said method further includes the steps of:
displaying a listing of the media files on the user interface sorted by the genre of music; and
viewing a listing of media files on the user interface sorted by their genre and listed by ranking in accordance with their vote totals.

16. The method of claim 9 wherein said method further includes the steps of:
limiting the votes by a user within a designated time period.

17. The method of claim 9 wherein said method further includes the steps of:
limiting the votes by a user within a designated time period within a designated genre.
